(19) United States
(12) Patent Application Publication
(10) Pub. No.: US 2009/0064806 A1
(43) Pub. Date: Mar. 12, 2009

(54) Starter with clutch coaxially disposed on output shaft of motor

(75) Inventor: Takashi Hirabayashi, Chita-gun (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/153,432

(22) Filed: May 19, 2008

(30) Foreign Application Priority Data
Sep. 12, 2007 (JP) 2007-236396

(51) Int. Cl. F02N 15/00

(52) U.S. Cl. 74/6

(57) ABSTRACT

A starter has a clutch coaxially disposed on an output shaft of a motor. The clutch has a clutch outer, an inner member having a clutch inner disposed on an inner side of the outer and a shaft portion disposed on a front side of the inner, a roller disposed between the outer and inner, a clutch cover attached to an outer surface of the outer and extending toward the shaft portion, and a clutch washer disposed on a front surface of the inner between the cover and inner. The distance between the cover and the rotation axis of the clutch is smaller than the distance between the outer end of the inner and the rotation axis. The rotation force of the motor is received in the outer and is transmitted to an engine through the roller and inner member to crank the engine.

### CROSS-REFERENCE TO RELATED APPLICATION

This application is based upon and claims the benefit of priority of the prior Japanese Patent Application 2007-236396 filed on Sep. 12, 2007, so that the contents of which are incorporated herein by reference.

### BACKGROUND OF THE INVENTION

1. Field of the Invention

The present invention relates generally to a starter for an internal combustion engine, and more particularly to the starter with a clutch coaxially disposed on an output shaft of a motor.

2. Description of Related Art

A starter has been used to crank an internal combustion engine mounted on a vehicle by transmitting a rotational force of a motor to the engine. This starter is, for example, disclosed in Published Japanese Patent First Publication No. 2007-16720. In this starter, a one-way clutch is coaxially disposed on an output shaft of a motor. When a pinion gear coupled with a shaft portion of the clutch is engaged with a ring gear of an engine, the pinion gear moves forward along an axial direction of the clutch and stops when the gears are placed at the same position in the axial direction. When the pinion gear stops, a clutch cover disposed on the clutch directly receives the inertia force directed in the axial direction from the shaft portion or indirectly receives the inertia force through a clutch washer.

FIG. 1 is a schematic side elevational view, partly in cross section, of a starter disclosed in Publication No. 2007-16720, while FIG. 2 is an enlarged sectional view of a clutch disposed in the starter.

As shown in FIG. 1 and FIG. 2, a starter 101 has a motor 102, an output shaft 104 of the motor 102, and a clutch 106 coaxially disposed on the output shaft 104 so as to be movable with the output shaft 104 along the axial direction of the clutch 106. The clutch 106 has an inner member 114, a clutch outer 113 disposed outside the inner member 114, a clutch roller 117 placed between the clutch outer 113 and the inner member 114, a clutch washer 118 for closing a space between the clutch outer 113 and the inner member 114, and a clutch cover 123 for placing the washer 118 on the clutch outer 113.

The clutch outer 113 has a twisted (or helical) female spline 113b coupled with a twisted male spline 104a of the output shaft 104, so that the clutch 106 can receive rotational force from the shaft 104 while being moved with the shaft 104a long the axial direction. The inner member 114 has a clutch inner 116 and a shaft portion 115 having a neck portion 115c integrally formed with the clutch inner 116 and being placed on the front side of the clutch inner 116. The outer diameter D11 of the clutch inner 116 is larger than the outer diameter of the neck portion 115c. The clutch inner 116 is disposed in a center space of the clutch outer 113 so as to be placed on the inner side of the roller 117 in the radial direction of the clutch 106 and to be in contact with the shaft 104. A pinion gear 105 is disposed to be coupled with a front portion of the shaft portion 115. The gear 105 is moveable with the shaft 115 along the axial direction of the output shaft 104 while being rotated with the shaft 115. The clutch washer 118 is attached to a front surface of the clutch inner 116 and a front surface of the clutch outer 113 so as to form a ring-shaped hole 118a between the washer 118 and the neck portion 115c of the shaft 115. The outer diameter of the hole 118a is smaller than the outer diameter D11 of the clutch inner 116. The clutch cover 123 has a circumferential wall 123a and a front wall 123b extended from the wall 123a towards the inner side in the radial direction. The wall 123a covers the outer circumferential surface of the clutch outer 113. The wall 123b covers a portion of the washer 118 disposed on the clutch outer 113. Therefore, the inner diameter D13 of the front wall 123b is considerably smaller than the outer diameter D11 of the clutch inner 116 When it is intended to start the driving operation of the engine, to obtain the engagement of the pinion gear 105 with a ring gear of the engine, the clutch 106 is moved forward along the axial direction by an interaction between the spline 113b of the clutch outer 113 and the spline 104a of the output shaft 104. When the pinion gear 105 is engaged with a ring gear of the engine, the movement of the pinion gear 105 is stopped. Then, the clutch 106 receives rotational force from the shaft 104 through the splines 104a and 113b, and the engine receives the rotational force from the clutch 106 through the gears. Then, the engine is cranked so as to start the driving operation. Thereafter, the clutch 106 is moved back to disengage the pinion gear 105 from the ring gear.

When the movement of the pinion gear 105 is stopped, the clutch cover 123 directly receives the inertia force from the shaft portion 115 or indirectly receives the inertia force through the clutch washer 118.

However, during the engagement of the gears to crank the engine, the pinion gear 105 is repeatedly moved along the axial direction by both the rotation in the engine and the interaction between the spline 113b of the clutch outer 113 and the spline 104a of the output shaft 104. Therefore, each time the pinion gear 105 is moved along the axial direction, the clutch inner 116 moved with the pinion gear 105 gains a forward movement and gives a pushing force caused by the forward movement to the front wall 123b of the clutch cover 123 through the clutch washer 118. This pushing force generates a bending moment in the front wall 123b such that the washer 118 pushes and outstretches the front wall 123b towards the outside (i.e., front side) of the clutch 106. In response to this bending moment, the clutch cover 123 is elastically deformed, so that an opening is momentarily formed between the clutch cover front wall 123b and the clutch outer 113.

FIG. 3 is an explanatory view showing the elastic deformation of the clutch cover 123 caused during the cranking of the engine.

As shown in FIG. 3, when the clutch cover 123 is elastically deformed, clutch grease packed in the space between the clutch outer 113 and the clutch inner 116 easily flows out from the clutch 106 through the opening. In this case, to smoothly operate the clutch 106, it is required to pack a large amount of clutch grease in the clutch 106, so that the clutch 106 is inevitably enlarged in size.

Another type of starter having a nut pinion stop is known. In this starter, the repetitive motion of a pinion gear is received by the pinion stop, so that a clutch cover receives no load derived from the bending moment. However, to reliably operate the clutch, a clutch 106 having no pinion stop undesirably becomes larger than a clutch having a pinion stop.

### SUMMARY OF THE INVENTION

An object of the present invention is to provide, with due consideration to the drawbacks of the conventional, a starter wherein elastic deformation of a clutch cover caused during the cranking of an engine is reduced.

According to an aspect of this invention, the object is achieved by the provision of a starter comprising a motor having an output shaft, and a clutch coaxially disposed on the output shaft of the motor. The clutch comprises a clutch outer for receiving a rotational force from the output shaft of the motor, an inner member having both a clutch inner disposed on an inner side of the clutch outer in a radial direction of the clutch and a shaft portion disposed on a front side of the clutch inner in an axial direction of the clutch and holding a pinion gear, a clutch roller disposed between an inner surface of the clutch outer and an outer surface of the clutch inner in the radial direction, a clutch cover having a side wall attached to an outer surface of the clutch outer and a front wall extended from a front end of the side wall toward a neck of the shaft portion adjacent to the clutch inner to cover an area from the clutch outer to the clutch inner on the front side of the clutch, and a clutch washer disposed on a front surface of the clutch inner to be placed between the clutch cover and the clutch inner. A size of the clutch inner in the radial direction is larger than a size of the neck so as to form the front surface of the clutch inner. When the clutch roller is in a rotational force transmission condition, the rotational force of the clutch outer is transmitted to the pinion gear through the clutch roller, the clutch inner and the shaft portion to crank an engine. A distance between the front wall and a rotation axis of the clutch is smaller than a distance between an outer end of the clutch inner in the radial direction and the rotation axis. The clutch washer has a hole so as to place the neck of the shaft portion into the hole with a clearance between them.

With this structure of the starter, the pinion gear is engaged with a ring gear of the engine to transmit the rotational force of the motor to the engine through the clutch and the gears, and the engine is cranked to start a driving operation. Then, the pinion gear is disengaged from the ring gear. However, during the engagement of the gears, the pinion gear is repeatedly moved along the axial direction of the clutch due to rotational movement in the engine and the interaction between the clutch outer and the output shaft transmitting the rotational force of the motor to the clutch outer. Therefore, the inner member gains forward movement from the pinion gear, so that the clutch cover repeatedly receives a pushing force caused by the forward movement through the clutch washer.

However, because the distance between the front wall and the rotation axis is set to be smaller than the distance between the outer end of the clutch inner and the rotation axis, the stiffness or rigidity of the clutch cover is heightened. Further, the clutch washer and the clutch cover are overlapped with the clutch inner in the radial direction. Therefore, during the engagement of the pinion gear with the ring gear to crank the engine, when the clutch cover receives the pushing force caused by the forward movement through the clutch washer, the pushing force mainly acts as a shearing force on the clutch cover, and bending forces acting on the clutch cover are suppressed.

Accordingly, the clutch can greatly reduce elastic deformation generated in the clutch cover, so that the clutch can prevent the front wall of the clutch cover from being pushed and outstretched towards the outside (i.e., front side) of the clutch.

Further, the front wall of the clutch cover narrows the open space between the clutch cover and the neck of the shaft portion. Therefore, clutch grease packed in the clutch so as to surround the clutch roller hardly leaks from the clutch through the open space. Accordingly, an amount of grease leaking from the clutch can be considerably reduced, so that the size and weight of the starter can be minimized.

### BRIEF DESCRIPTION OF THE DRAWINGS

FIG. 1 is a schematic side elevational view, partly in cross section, of a conventional starter;

FIG. 2 is an enlarged sectional view of a clutch disposed in the starter shown in FIG. 1;

FIG. 3 is an explanatory view showing elastic deformation of a clutch cover caused during the cranking of an engine;

FIG. 4 is a side elevational view, partly in cross section, of a starter according to an embodiment of the present invention;

FIG. 5 is an enlarged sectional view of a clutch disposed in the starter shown in FIG. 4; and

FIG. 6 is a sectional view, seen from the front side of the starter, of a clutch roller and its surroundings in the clutch shown in FIG. 5.

### DETAILED DESCRIPTION OF THE PREFERRED EMBODIMENTS

An embodiment of the present invention will now be described with reference to the accompanying drawings.

### Embodiment

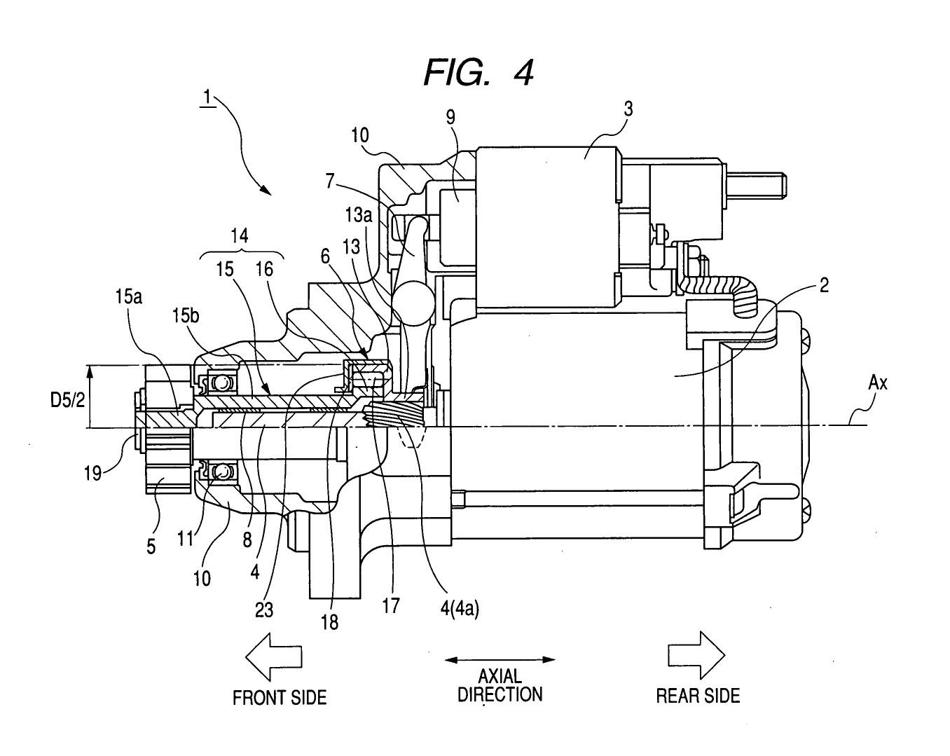

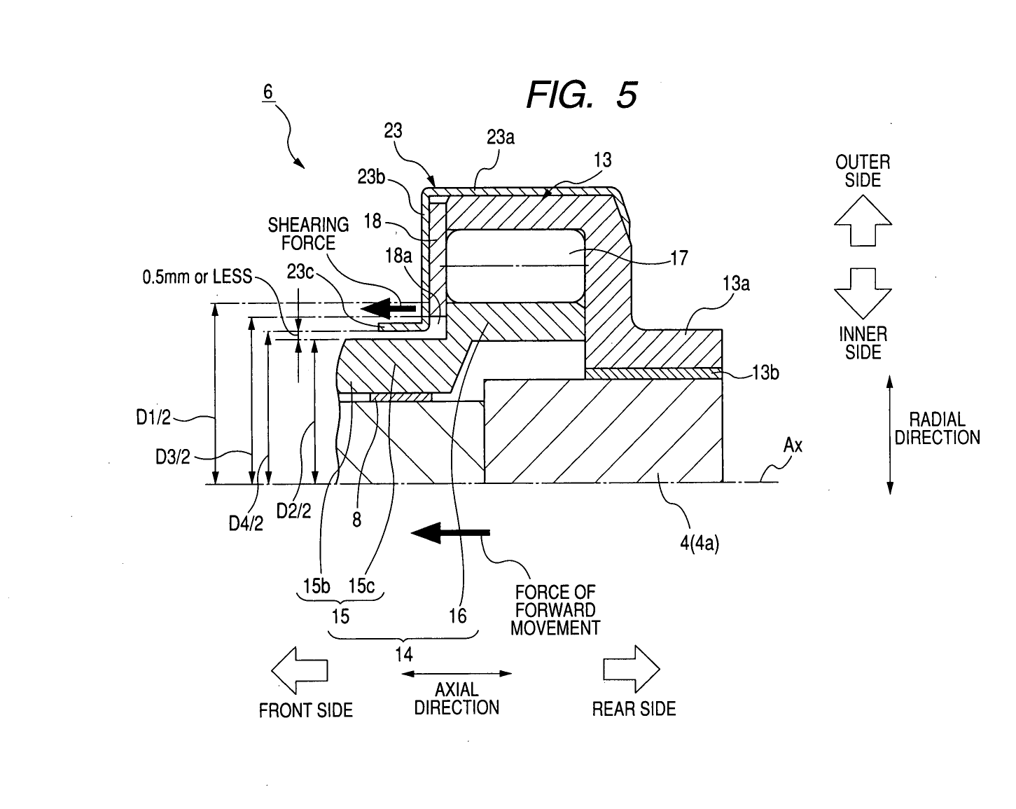

FIG. 4 is a side elevational view, partly in cross section, of a starter according to this embodiment, while FIG. 5 is an enlarged sectional view of a clutch disposed in the starter.

As shown in FIG. 4 and FIG. 5, a starter 1 for cranking an internal combustion engine is, for example, disposed on a vehicle. The starter 1 has a motor 2 for generating a rotational force, an electromagnetic switch 3 for electrically connecting the motor 2 to a battery (not shown) and electrically disconnecting the motor 2 from the battery, an output shaft 4 fixedly connected with the motor 2 so as to be rotated on its own axis, a one-way clutch 6 coaxially coupled with both the output shaft 4 and a pinion gear 5 to transmit the rotational force from the output shaft 4 to the pinion gear 5, and a shift lever 7. The output shaft 4, the clutch 6 and the pinion gear 5 are rotatable on an axis Ax of rotation.

The motor 2 is, for example, formed of a well-known direct current (AC) motor having a magnetic field generator and an armature. When the switch 3 connects contact points of a main contact (not shown) with each other, electric power is supplied from a battery to the armature through the main contact so as to generate a rotational force in the motor 2.

The switch 3 has an exciting coil (not shown) and a plunger 9. In response to a turn-on of a starting switch (not shown), electric power is supplied from the battery to the exciting coil to move the plunger 9 due to a magnetic field generated in the exciting coil. In response to the movement of the plunger 9, the contact points of the main contact are connected with each other.

The output shaft 4 is coaxially disposed with a shaft of the armature of the motor 2 and is connected with the armature shaft through a rotational speed reducing unit (not shown). This reducing unit is, for example, formed of a well-known planetary gear type speed reducer. This reducer reduces the rotational speed of the armature shaft to a revolving speed of a planetary gear and transmits the rotational force to the output shaft 4 at the reduced rotational speed. The output shaft 4 has a twisted male spline 4a on its outer circumferential surface. The armature shaft may be directly connected with the output shaft 4 without using any reducing unit.

The clutch 6 has a clutch outer 13 approximately formed in a cap shape and an inner member 14 approximately formed in a cylindrical shape. The center axis of the clutch outer 13 extending along the axial direction agrees with the rotation axis Ax. The center axis of the inner member 14 agrees with the rotation axis Ax. The clutch outer 13 is disposed on an outer side of the clutch 6 in a radial direction of the clutch 6. The clutch outer 13 has a clutch barrel 13a on the rear side of the clutch 6 in an axial direction of the clutch 6. The outer diameter of the barrel 13a is smaller than the outer diameter of the center portion of the clutch outer 13. The barrel 13a has a twisted female spline 13b on its inner circumferential surface. The spline 13b of the barrel 13a is coupled with the spline 4a of the output shaft 4 such that the barrel 13a placed on the output shaft 4 receives the rotational force from the output shaft 4.

The inner member 14 has a shaft portion 15 and a clutch inner 16 integrally formed with each other. The shaft portion 15 is disposed on the front side of the clutch inner 16 in the axial direction. The clutch inner 16 is disposed on the inner side of the clutch 6 in the radial direction so as to be placed in the center space of the clutch outer 13 and to be in contact with a rear portion of the clutch outer 13. The shaft portion 15 has both a front end portion 15a supporting the pinion gear 5, a body portion 15b placed on the rear side of the portion 15a, and a neck 15c integrally formed with the clutch inner 16. The outer diameter D1 of the clutch inner 16 is larger than the outer diameter D2 of the neck 15c of the shaft portion 15 so as to form a front surface 16a of the clutch inner 16.

The clutch 6 further has a clutch roller 17 disposed between the clutch outer 13 and the clutch inner 16 along the radial direction, a clutch cover 23 fitted to the clutch outer 13 so as to cover the area from the clutch outer 13 to the clutch inner 16 on the front side of the clutch outer 13, and a clutch washer 18 disposed on the front surface 16a of the clutch inner 16 to be placed between the clutch cover 23 and the clutch inner 16. The washer 18 may also be disposed on a front end surface of the clutch outer 13 so as to close the open space between the clutch outer 13 and the clutch inner 16.

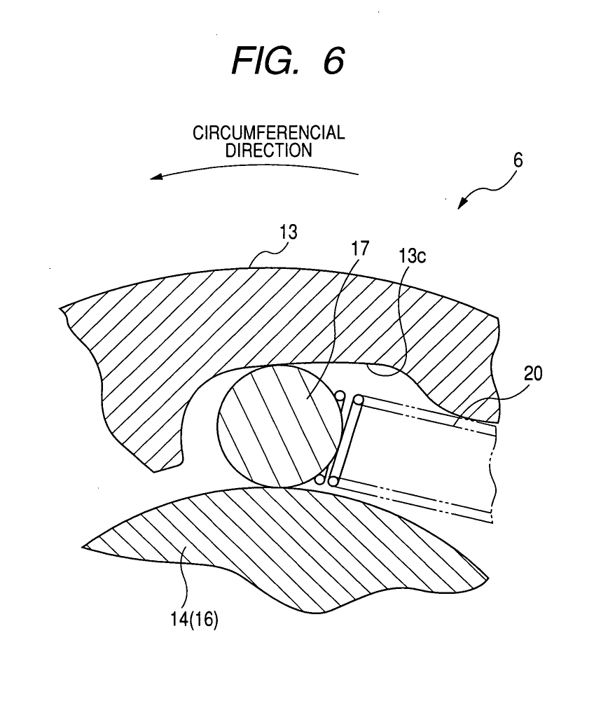

The clutch roller 17 is a type of clutch engagement formed in a roller shape. The roller 17 is placed to be rotatively in contact with the inner circumferential surface of the clutch outer 13 and the outer circumferential surface of the clutch inner 16. FIG. 6 is a sectional view, seen from the front side, of the clutch roller 17 and its surroundings. As shown in FIG. 6, the roller 17 is disposed in a cam chamber 13c between the clutch outer 13 and the clutch inner 16. The width of the chamber 13c in the radial direction of the clutch 6 is gradually narrowed along a circumferential direction of the clutch 6. A spring 20 forcibly pushes the roller 17 toward a width narrowing side of the circumferential direction. When the clutch outer 13 is rotated on the rotation axis Ax, the roller 17 is moved toward the width narrowing side so as to be locked between the outer circumferential surface of the clutch inner 16 and the inner circumferential surface of the clutch outer 13. Therefore, the roller 17 is set in a rotational force transmission condition, and the rotational force of the clutch outer 13 is transmitted to the clutch inner 16 though the roller 17. In contrast, after the engine starts its driving operation so as to give a rotational force to the clutch inner 16, the rotational speed of the clutch inner 16 exceeds the rotational speed of the clutch outer 13, and the roller 17 is moved against the pushing force of the spring 20 toward a width widening side opposite to the width narrowing side so as to unlock the roller 17 in the chamber 13c. Therefore, the roller 17 is set in a non-transmission condition, and no torque is transmitted between the clutch inner 16 and the clutch outer 13.

The clutch washer 18 is formed in a ring shape so as to have a hole 18a having a diameter D3 smaller than the outer diameter D1 of the clutch inner 16 and larger than the outer diameter D2 of the neck 15c of the shaft portion 15. Therefore, the washer 18 faces the neck 15c placed into the hole 18a through a space. The washer 18 is movably disposed on the front end surface of the clutch outer 13 and the front surface 16a of the clutch inner 16. The washer 18 is made of a material having high wear resistance. Therefore, even when the rotational speed of the clutch outer 13 differs from that of the clutch inner 16, the washer 18 can be stably slid on at least one of the clutch outer 13 and the clutch inner 16.

The clutch cover 23 is obtained by deforming a steel plate. The clutch cover 23 has a circumferential side wall 23a approximately formed in a tubular shape to cover the outer circumferential surface of the clutch outer 13, a ring-shaped front wall 23b extended from the front end of the wall 23a toward the inner side in the radial direction so as to be in contact with the front surface of the washer 18, and a tubular portion 23c extended from the inner circumferential end of the wall 23b toward the front side so as to face the outer circumferential surface of the neck 15c of the shaft portion 15 through a space. The rear end portion of the wall 23a is tightly fitted to the rear end surface of the clutch outer 13 such that the cover 23 is fixedly attached to the clutch outer 13. Therefore, the cover 23 tightly holds the washer 18 to close the cam chamber 13c.

An inner diameter D4 of the front wall 23b is set to be smaller than the outer diameter D1 of the clutch inner 16. Therefore, even when the inner member 14 repeatedly moves along the axial direction during the cranking of the engine to have a forward movement, the clutch cover 23 is configured to directly receive a pushing force caused by the forward movement of the inner member 14 or to indirectly receive the pushing force through the clutch washer 18.

The outer diameter D2 of the neck 15c of the inner member 14 is smaller than the inner diameter D4 of the front wall 23b so as to form a space between the neck 15c of the shaft portion 15 and the clutch cover 23. For example, this space is set at 0.5 mm so as to prevent the clutch cover 23 from coming in contact with the inner member 14.

A bearing 8 is pressed into an inner space of the portion 15b so as to be in contact with the inner circumferential surface of the portion 15b. The shaft portion 15 is fitted to the outer circumferential surface of the output shaft 4 through the bearing 8 so as to rotate on the output shaft 4 and to be slid on the output shaft 4 along the axial direction. Further, the shaft portion 15 is supported by a housing 10 through another bearing 11 (e.g., ball bearing) held by the housing 10 so as to rotate on the housing 10 and to be slid on the housing 10 along the axial direction.

The outer diameter of the front end portion 15a is smaller than the outer diameter of the body portion 15b, so that there is a corner between the portions 15a and 15b. The corner prevents the pinion gear 5 from being placed on the portion 15b. The pinion gear 5 is fitted to the portion 15a protruded from the housing 10 in the straight spline coupling. A retainer 19 disposed on the front end of the portion 15a prevents the pinion gear 5 from coming out from the portion 15a.

The operation of the starter 1 will be described below. When a starting switch is turned on, an exciting coil of the switch 3 receives electric current from a battery to generate a magnetic field around the exciting coil, and the plunger 9 is attracted or drawn by the magnetic field towards the switch 3. The moved plunger 9 connects the contact points of the main contact, and one end of the shift lever 7 connected with the plunger 9 is moved towards an anti-motor side (i.e., front side) opposite to the side of the motor 2. The moved shift lever 7 pushes the clutch 6 towards the anti-motor side. Therefore, the clutch 6 is moved with the pinion gear 5 towards the anti-motor side along the axial direction, and a front end surface of the pinion gear 5 comes in contact with a rear end surface of a ring gear (not shown) of the motor.

Further, when the contact points of the main contact are connected with each other in response to the movement of the plunger 9, electric power of the battery is supplied to an armature of the motor 2, so that the motor 2 generates a rotational force. This rotational force is transmitted to the output shaft 4 through the reducing unit. The rotational force of the output shaft 4 is transmitted to the pinion gear 5 through the twisted spline 4a of the output shaft 4, the twisted spline 13b of the clutch outer 13 and the inner member 14, so that the pinion gear 5 is rotated on the surface of the ring gear by the rotational force of the motor 2. When the pinion gear 5 is rotationally moved to a particular position at which the engagement of the pinion gear 5 with the ring gear is allowed, the pinion gear 5 is engaged with the ring gear. Then, the rotational force is transmitted from the pinion gear 5 to the ring gear to crank the engine.

Then, when the engine is successfully cranked so as to stably transmit the rotational force of the engine to the clutch 6, the starting switch is turned off, the magnetic field of the exciting coil of the switch 3 disappears, and the plunger 9 is pushed back by a return spring (not shown). Therefore, the contact points of the main contact are disconnected from each other, and the supply of the electric power to the motor 2 is stopped. Further, the shift lever 7 is moved toward the side of the motor 2 by the plunger 9, so that the clutch 6 is moved back with the pinion gear 5 toward the side of the motor 2 by the shift lever 7. Therefore, the pinion gear 5 is detached from the ring gear, and the engine continues its driving operation.

As described above, in the starter 1 according to this embodiment, the clutch 6 coaxially disposed on the output shaft 4 of the motor 2 has the clutch outer 13 receiving the rotational force from the output shaft 4, the inner member 14 having the clutch inner 16 and the shaft portion 15 such that the size of the clutch inner 16 in the radial direction is larger than the size of the neck 15c of the shaft portion 15, the clutch roller 17 disposed between the clutch outer 13 and the clutch inner 16, the clutch cover 23 covering the area from the clutch outer 13 to the clutch inner 16 on the front side of the clutch 6, and the clutch washer 18 disposed on the front surface of the clutch inner 16.

The clutch cover 23 has the side wall 23a attached to the outer circumferential surface of the clutch outer 13 and the front wall 23b extended from a front end of the side wall 23a toward the neck 15c of the shaft portion 15. The clutch washer 18 is placed between the front wall 23b of the cover 23 and the clutch inner 16. The clutch washer 18 has a hole 18a so as to place the neck 16a of the shaft portion 15 into the hole 18a with some clearance between them. The distance (i.e., half of diameter D4) between the front wall 23b and the rotation axis Ax is smaller than the distance (i.e., half of diameter D1) between the outer end of the clutch inner 16 in the radial direction and the rotation axis Ax.

With this structure of the starter 1, because the inner diameter D4 of the front wall 23b is smaller than the outer diameter D1 of the clutch inner 16, stiffness or rigidity of the clutch cover 23 can be heightened, and the clutch washer 18, the clutch cover 23 and the clutch inner 16 are overlapped with one another in the axial direction. Therefore, during the engagement of the pinion gear 5 with the ring gear to crank the engine, there is an interaction of the splines 4a and 13b caused by the rotational force of the motor 2, and the inner member 14 gains forward movement along the axial direction from the rotation of the engine and the interaction of the splines 4a and 13b. When the clutch cover 23 receives a pushing force caused by the forward movement of the inner member 14, the pushing force mainly acts as a shearing force on the clutch cover 23, and the bending moment acting on the clutch cover 23 is suppressed.

Accordingly, the clutch 6 can greatly reduce elastic deformation generated in the clutch cover 23, so that the clutch 6 can prevent the front wall 23b of the clutch cover 23 from being pushed and stretched outwards to the front side of the clutch 6.

Further, the front wall 23b of the clutch cover 23 narrows the open space between the clutch cover 23 and the neck 15c of the shaft portion 15. Therefore, clutch grease packed in the chamber 13c of the clutch 6 hardly leaks from the clutch 6 through the open space. Accordingly, the amount of grease leaking from the clutch 6 can be considerably reduced, so that the size and weight of the starter 1 can be minimized.

Moreover, the shaft portion 15 of the inner member 14 is configured such that the outer diameter of the shaft portion 15 is smaller than the inner diameter D4 of the front wall 23b at any point in the axial direction. Therefore, after the inner member 14 and the washer 18 are attached to the clutch outer 13, the shaft portion 15 not yet having the pinion gear 5 is inserted into the hole of the clutch cover 23 from the front side to the rear side of the starter 1, and the clutch cover 23 is attached to the clutch outer 13. Accordingly, the clutch cover 23 can be easily attached to the clutch outer 13.

Furthermore, the front wall 23b of the clutch cover 23 is disposed to be away from the neck 15c of the shaft portion 15 by a small distance such as 0.5 mm or less in the radial direction, so that the clutch cover 23 can be prevented from being in contact with the inner member 14. Accordingly, because the inner diameter D4 of the front wall 23b is minimized, the stiffness or rigidity of the clutch cover 23 can be reliably heightened, and the amount of grease leaking from the clutch 6 can be reliably reduced.

Still further, the clutch cover 23 has the tubular portion 23c extended from the inner end of the wall 23b toward the front side, the stiffness or rigidity of the clutch cover 23 can be further heightened.

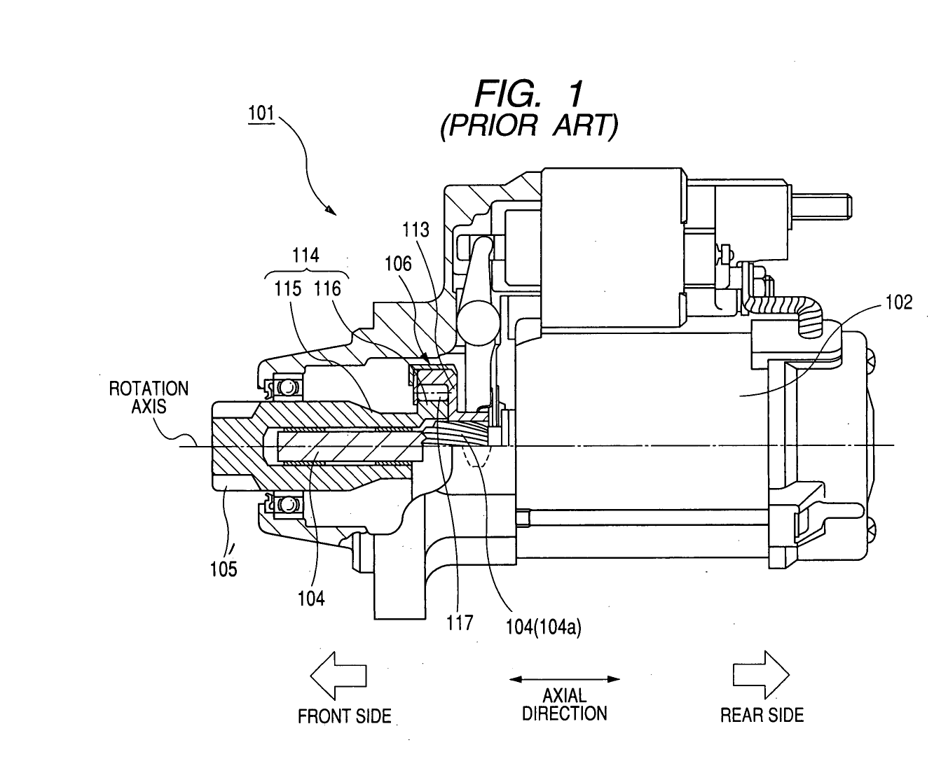

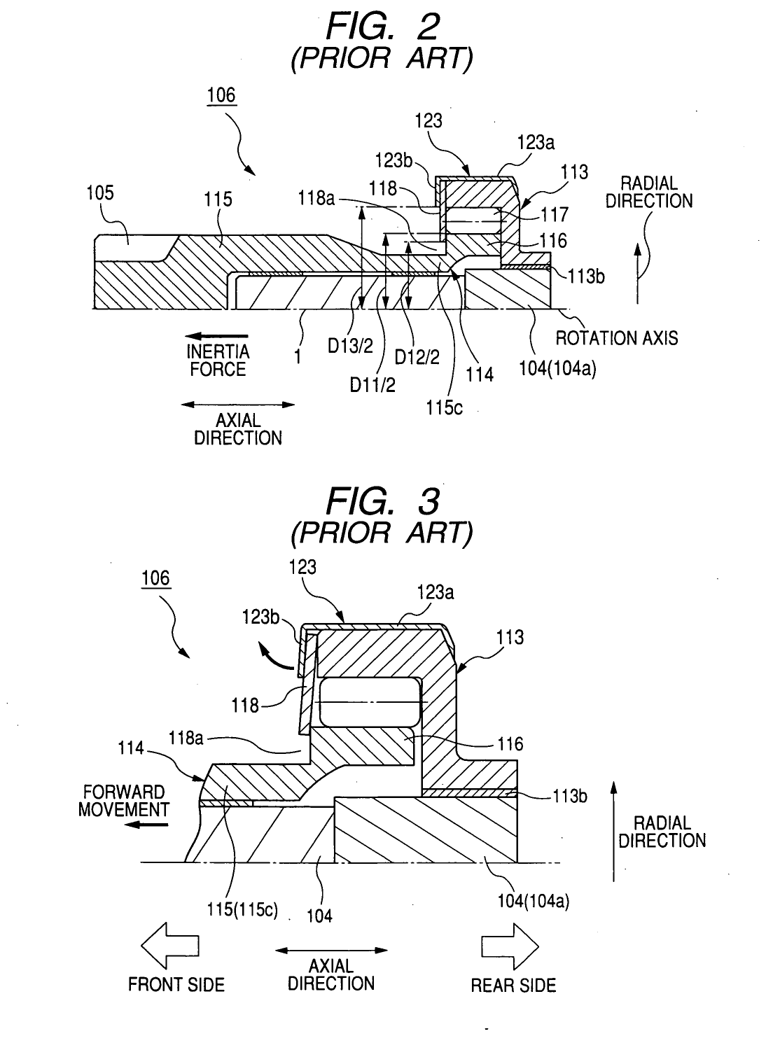

Still further, the pinion gear 5 is formed separately from the shaft portion 15. After the clutch cover 23 is attached to the clutch outer 13, the pinion gear 5 is disposed on the front end portion 15a of the shaft portion 15. Therefore, when the clutch cover 23 is disposed in the clutch 6, it is not required to place the pinion gear 5 into an open space surrounded by the front wall 23b in the mounting process. That is, even when the pinion gear 5 has an outer diameter D5 (i.e., distance between tooth ends) larger than the diameter of the open space of the front wall 23b, the pinion gear 5 can be coupled with the shaft portion 15. Accordingly, although the size of the pinion gear 5 is determined so as to match with the engine, the freedom in design of the pinion gear 5 can be largely improved while the size and weight of the clutch 6 are minimized. For example, as shown in FIG. 1, the pinion gear 5 having a diameter larger than the outer diameter of the clutch 6 (i.e., clutch outer 13) can be disposed on the shaft portion 15. Further, regardless of the design of the pinion gear 5, the outer diameter of the shaft portion 15 can be set at a minimum value required for the starter 1. Accordingly, a nose section of the starter 1 including the shaft portion 15 and the bearing 11 can be downsized, and the starter 1 can be disposed in a smaller space of the vehicle.

This embodiment should not be construed as limiting the present invention to the structure of this embodiment, and the structure of this invention may be combined with that based on the prior art.

For example, in this embodiment, the clutch cover 23 has the tubular portion 23c. However, the clutch cover 23 may have no portion extended from the inner end of the wall 23b toward the front side on condition that the inner diameter D4 of the front wall 23b is smaller than the outer diameter D1 of the clutch inner 16.

Further, in this embodiment, the front wall 23b of the cover 23 extends toward the inner side such that the inner diameter D4 of the front wall 23b is smaller than the diameter D3 of the hole 18a of the washer 18. However, the inner diameter D4 may be set to be equal to or larger than the diameter D3 on condition that the inner diameter D4 is smaller than the outer diameter D1 of the clutch inner 16.

What is claimed is:

1. A starter, comprising:
a motor having an output shaft; and
a clutch coaxially disposed on the output shaft of the motor,
wherein the clutch comprises:
a clutch outer for receiving rotational force from the output shaft of the motor;
an inner member having a clutch inner and a shaft portion, the clutch inner being disposed on an inner side of the clutch outer in a radial direction of the clutch, the shaft portion being disposed on a front side of the clutch inner in an axial direction of the clutch and holding a pinion gear, the shaft portion having a neck adjacent to the clutch inner, a size of the clutch inner in the radial direction being larger than a size of the neck so as to form a front surface of the clutch inner;
a clutch roller disposed between an inner surface of the clutch outer and an outer surface of the clutch inner in the radial direction such that, when the clutch roller is in a rotational force transmission condition, the rotational force of the clutch outer is transmitted to the pinion gear through the clutch roller, the clutch inner and the shaft portion to crank an engine;
a clutch cover having a side wall attached to an outer surface of the clutch outer and a front wall extended from a front end of the side wall toward the neck of the shaft portion to cover an area from the clutch outer to the clutch inner on the front side of the clutch, a distance between the front wall and a rotation axis of the clutch being smaller than a distance between an outer end of the clutch inner in the radial direction and the rotation axis; and
a clutch washer disposed on the front surface of the clutch inner to be placed between the clutch cover and the clutch inner, the clutch washer having a hole so as to place the neck of the shaft portion into the hole with a clearance between them.

2. The starter according to claim 1, wherein a distance between an outer surface of the shaft portion in the radial direction and the rotation axis is smaller than the distance between the front wall and the rotation axis at any point in the axial direction.

3. The starter according to claim 1, wherein the front wall of the clutch cover is disposed away from the neck of the shaft portion.

4. The starter according to claim 1, wherein the front wall of the clutch cover is disposed to be away from the neck of the shaft portion by 0.5 mm or less in the radial direction.

5. The starter according to claim 1, wherein the clutch cover has a tubular portion extended from an inner end of the front wall toward the front side of the clutch so as to face the shaft portion through a space.

6. The starter according to claim 1, further comprising a pinion gear disposed on a front end of the shaft portion such that the pinion gear disposed separately from the shaft portion is coupled with the shaft portion, the pinion gear being engaged with a gear of the engine to transmit the rotational force to the engine through the gears.

7. The starter according to claim 1, wherein the clutch inner has a cylindrical shape having a center axis agreeing with the rotation axis, the front wall of the clutch cover has a ring shape having a center through which the rotation axis passes, and an inner diameter of the front wall is set to be smaller than an outer diameter of the clutch inner.
